(19) United States
(12) Patent Application Publication
(10) Pub. No.: US 2026/0261530 A1
(43) Pub. Date: Sep. 3, 2026

(54) PACKET PROCESSING SYSTEMS FOR WIRELESS COMMUNICATION DEVICES

(71) Applicant: Morse Micro Pty. Ltd., Surry Hills NSW (AU)

(72) Inventors: James Stuart, Sydney (AU); Julius Baxter, Sydney (AU); Sam Shahrestani, Sydney (AU); Bassem Dawood, Sydney (AU)

(21) Appl. No.: 19/550,837

(22) Filed: Feb. 26, 2026

(30) Foreign Application Priority Data
Mar. 3, 2025 (AU) 2025900614

(51) Int. Cl. H04L 49/9005; H04L 49/901; H04L 49/9057

(52) U.S. Cl. CPC H04L 49/9005; H04L 49/901; H04L 49/9057

(57) ABSTRACT

A packet processing system for a wireless communication device includes memory organized into pools of pages. A packet allocator assigns pages from a selected pool for each packet. RX packets are reconstructed from an RX byte stream and stored in an RX pool of memory pages by an RX deserializer. An RX serializer outputs a host-bound serial stream from the stored RX packets. TX packets are formed from a serialized input stream by a TX deserializer and stored in a TX pool of memory pages allocated by the packet allocator. A TX serializer converts the stored TX packets into a TX byte stream for transmission. A packet virtualization unit exposes a virtual contiguous address mapping for packets stored in the memory by receiving a software access request and identifying a physical address and an offset according to a metadata retrieved for a contiguous virtual page window.

### CROSS REFERENCE TO RELATED APPLICATION

This application claims the benefit of priority from Australian provisional patent application number 2025900614 filed on 3 Mar. 2025, which is hereby incorporated by reference, in its entirety and for all purposes.

### FIELD

The present disclosure generally relates to wireless communication devices. Specifically, aspects of the present disclosure are related to packet processing and transferring in wireless communication devices.

### BACKGROUND

A wireless communication device, such as a Wi-Fi-enabled device, comprises distinct components that work together to ensure seamless data transmission. At its foundation, a radio module, also referred to as a physical (PHY) layer, manages the transmission and reception of wireless signals over the air. The radio module is responsible for modulation, demodulation, and other low-level signal processing tasks. Complementing it is a host module, typically the wireless communication device's main processor, which handles higher-layer protocols, packet processing, application execution, and overall system coordination. Communication between the radio module and host module is facilitated by an interface, which transports both data streams and control information. To regulate data flow, a packet processing system acts as an intermediary, dynamically allocating and deallocating memory for packets traveling between the radio and host modules. It provides temporary storage for incoming and outgoing data, ensuring smooth packet handling, regulating the flow of packets between the two modules to prevent buffer overflows or underflows, and supporting Quality of Service (QoS) requirements. Specifically, the packet processing system provides temporary storage for packets received from the radio module before they are processed by the host module, likewise, it buffers outgoing packets from the host module before sending them to the radio module for radio transmission. Its dynamic memory allocation accommodates variable packet sizes and fluctuating traffic loads. Closely integrated with the Media Access Control (MAC) layer, this packet processing system offers a unified memory interface that ensures efficient interaction between subsystems within the wireless communication device.

Beyond buffering, the packet processing system in the wireless communication device plays a critical role in optimizing memory usage to meet application demands. It implements memory management which allows the device to execute programs that require more memory than is physically available by swapping portions of processes (pages) in and out of memory as needed, for example, swapping data between fast but limited physical memory, such as Random Access Memory (RAM), and slower storage such as flash or hard drive. This functionality is vital for multitasking environments, where multiple applications or services compete for constrained memory resources. In the context of Wi-Fi devices, the packet processing system ensures that memory-intensive networking tasks, such as protocol processing or large data buffer handling, can coexist with other system functions without exhausting physical memory. By efficiently managing memory resources and maintaining seamless task execution, the packet processing system preserves both performance and reliability of the wireless communication device, even under heavy workload conditions.

### SUMMARY

The following summary presents technical features relating to one or more aspects disclosed herein and should not be considered as an extensive overview relating to all contemplated aspects. Accordingly, the following summary has the sole purpose to present certain concepts relating to one or more embodiments relating to packet processing disclosed herein in a simplified form to precede the detailed description presented below.

A packet processing system in a wireless communication device operating in a wireless communication network includes a memory comprising multiple memory pages organized into pools of memory pages, a packet allocator, receiver (RX) and transmitter (TX) deserializers, RX and TX serializers, and a packet virtualization unit (PVU). The packet allocator is configured to dynamically assign one or more memory pages from the pool of memory pages for each packet, and to associate each stored packet with a packet pointer that references a metadata of the stored packet. The RX deserializer receives an RX byte stream from a Medium Access Control (MAC) layer, reconstructs RX packets from the RX byte stream and stores the RX packets in an RX pool of memory pages allocated by the packet allocator. The RX serializer coupled to the memory to serialize the RX packets stored in the RX pool of memory pages and output a host-bound serial stream to a host module via a host interface. The TX deserializer receives a serialized byte stream from the host module via the host interface, forms TX packets from the serialized byte stream, and stores the TX packets to a TX pool of memory pages dynamically allocated by the packet allocator. The RX pool and TX pool are within the pools of memory pages. The TX serializer converts the TX packets stored in the TX pool of memory pages into a TX byte stream for transmission. The PVU exposes a virtual contiguous address mapping for at least one packet stored in the memory. The PVU receives a software access request including a given packet pointer and a virtual address for accessing a portion of a given packet, retrieves a metadata referenced by the given packet pointer to offer a contiguous virtual address window (e.g., a contiguous virtual page window), and determines a physical address of the memory page for storing the portion of the given packet and an offset within the memory page by translating the virtual address using the contiguous virtual page window.

Some embodiments of the packet allocator assign one or more memory pages from the pools for each packet according to a traffic flow of each packet, the traffic flow is selected from a group of types of traffic flow including at least one of a transmit, receive, command, and response traffic flow. At least one of the pools is used to store packets belonging to each type of traffic flow. The packet allocator is configured to resize the RX packet dynamically while receiving the RX byte stream according to an embodiment of the present disclosure.

In some embodiments, the packet virtualization unit includes mapping entries, each mapping a RX or TX packet into the contiguous virtual page window accessible by software for reading and writing. The RX deserializer or TX deserializer addresses synchronization errors by automatically causing a reset of an internal state when the software access request starts at a base address of the contiguous virtual page window. Each packet comprises a delimiter including metadata indicating a packet size and type. In order to assign memory pages to store each packet, the packet allocator uses the packet pointer to point to a corresponding metadata page allocated to each packet.

In one embodiment, the packet allocator examines a pool identifier (ID) contained in a delimiter of the RX byte stream, selects the RX pool of memory pages corresponding to the pool ID, assigns one memory page from the RX pool of memory pages to be used as a metadata page for a reconstructed RX packet, assigns one or more memory pages from the RX pool to store packet contents of the reconstructed RX, and writes a page list into the metadata page identifying the one or more memory pages assigned to store the packet contents.

In one aspect of the packet processing system, the RX deserializer and TX deserializer reconstruct the RX packets and TX packets on the fly using the packet allocator.

Some embodiments of the packet processing system further comprise a register configured to indicate packet allocation is unsuccessful when there is a lack of available memory pages in a respective pool, wherein the register stores a copy of a delimiter.

An aspect of the RX and TX serializers is each serializer functions as a read-only interface, the RX serializer is triggered by the host module to read packet contents stored in the RX pool of memory pages, the TX serializer is triggered by the MAC layer to read packet contents stored in the TX pool of memory pages. Each of the RX and TX serializers maintains state information and tracks a current read position within a packet.

Some embodiments of the packet allocator assign the memory pages for the RX packets in accordance with one or a combination of a TX status, response, and events. Similarly, some embodiments of the packet allocator assign the memory pages for the TX packets in accordance with a control signal from the MAC layer. Some examples of the control signal include one or a combination of a block acknowledgement (ACK), request to send (RTS), and clear to send (CTS).

In some embodiments, the RX and TX pools of memory pages for storing the RX packets and TX packets may be implemented by an on-chip memory-mapped Random Access memory (RAM).

In some embodiments, the packet processing system further includes a unified status block across the RX deserializer, RX serializer, TX deserializer, and TX serializer, for aggregating a queue depth, page availability, and state of the RX deserializer, RX serializer, TX deserializer, and TX serializer.

Some embodiments of the software access request include a memory read or write operation initiated by software instructions, the PVU outputs the physical address and the offset within the memory page such that the software accesses the portion of the given packet directly using the physical address and the offset. The PVU enables sequential software access across multiple non-contiguous memory pages as a logically contiguous memory region according to the virtual contiguous address mapping.

One aspect of the present disclosure is a wireless communication device operating in a wireless communication network, including a radio module, a PHY system, a host system, and a MAC system. The radio module is composed of a Radio Frequency (RF) transmitter and an RF receiver. The PHY system demodulates a received signal received by the RF receiver and modulates into a transmit signal to be transmitted by the RF transmitter. The host system runs high level functionalities of the wireless communication device. The MAC system is the bridge between the PHY system and the host system, comprising a memory comprising memory pages organized into pools of memory pages, a packet allocator, a RX deserializer and serializer, a TX deserializer and serializer, and a packet virtualization unit. The packet allocator assigns one or more memory pages from the pools of memory pages to store each packet, and associates each stored packet with a packet pointer that references a metadata of the stored packet. The RX deserializer receives a RX byte stream from the PHY system, reconstructs RX packets from the RX byte stream, and stores the RX packets into a RX pool of memory pages allocated by the packet allocator. The RX serializer coupled to the memory to serialize the RX packets stored in the RX pool of memory pages and output a host-bound serial stream to the host system. The TX deserializer receives a serialized byte stream from the host system, forms TX packets from the serialized byte stream, and stores the TX packets to a TX pool of memory pages dynamically allocated by the packet allocator. The TX serializer converts the TX packets stored in the TX pool of memory pages into a TX byte stream for the PHY system. The RX and TX pools of memory pages are within the pools of memory pages. The PVU exposes a virtual contiguous address mapping of at least one packet stored in the memory. Specifically, the PVU receives a software access request comprising a given packet pointer and a virtual address for accessing a portion of a given packet, retrieves a metadata referenced by the given packet pointer to offer a contiguous virtual page window, and determines a physical address of the memory page for storing the portion of the given packet and an offset within the memory page by translating the virtual address using the contiguous virtual page window.

Other objects and advantages associated with the aspects disclosed herein will be apparent to those skilled in art based on the accompanying drawings and detailed description.

### BRIEF DESCRIPTION OF THE DRAWINGS

Illustrative aspects of the present application are described in detail below with reference to the following drawing figures:

FIG. 1 illustrates a block diagram of a packet processing system in accordance with an embodiment of the present disclosure.

FIG. 2 illustrates a system employing multiple serializers and deserializers to support wireless reception and transmission by a wireless communication device in accordance with an embodiment of the present disclosure.

FIG. 3 illustrates a data byte stream carrying packets transferred to a virtual memory window of a deserializer in accordance with an embodiment of the present disclosure.

FIG. 4 illustrates a block diagram of a wireless communication device implementing the packet processing system according to an embodiment of the present disclosure.

FIG. 5 illustrates a block diagram of an exemplary MAC system in a wireless communication device according to an embodiment of the present disclosure.

### DETAILED DESCRIPTION

Certain aspects and embodiments of this disclosure are provided below. Some of these embodiments may be applied independently and some of them may be applied in conjunction as would be apparent to those of skill in the art. In the following description, for the purposes of explanation, specific details are set forth to provide a thorough understanding of aspects of the application. However, it will be apparent that various embodiments may be practiced without these specific details. The following description of the embodiments will provide those skilled in the art with an enabling description for implementing an example aspect. Changes may be made in the function and arrangement of elements without departing from the spirit and scope of the application as set forth in the claims.

In some embodiments, software described in the present disclosure may be implemented as firmware stored in memory and executed by embedded processing logic. Conversely, firmware may be implemented as software executed by a host processor, microcontroller, or any programmable logic. The terms “software” and “firmware” are used interchangeably in the present disclosure, as software and firmware each refer to executable instructions stored in a non-transitory computer-readable medium and executed by one or more processing units of the wireless communication device. These executable instructions may be stored in volatile memory, non-volatile memory, on-chip memory, off-chip memory, or a combination thereof. Accordingly, references to firmware access requests, firmware-initiated operations, or firmware processing shall be understood to encompass software-implemented operations executed by a process, and vice versa.

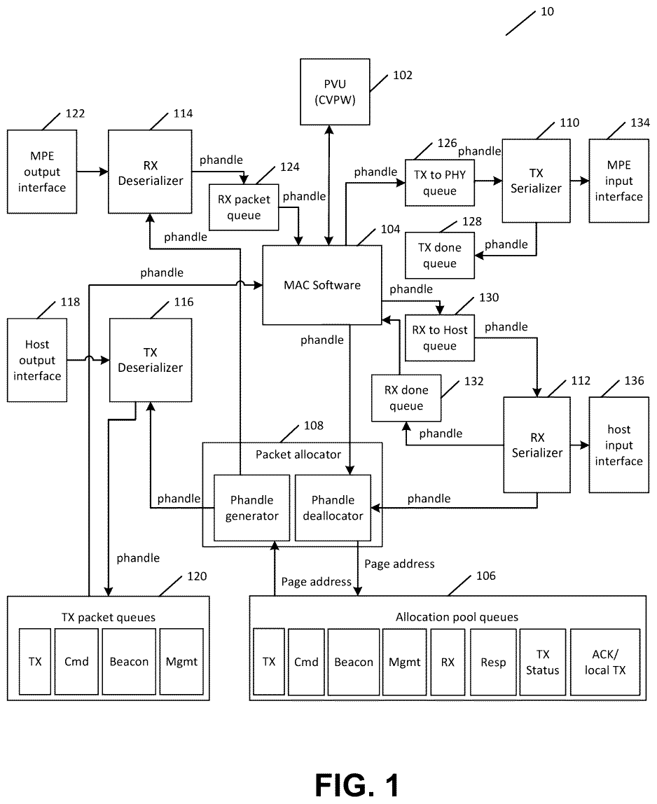

In one aspect, a packet processing system manages memory storage for packets as the packets transfer between multiple modules in a wireless communication device. The packet processing system is implemented primarily in hardware to minimize software intervention while achieving efficient utilization of physical memory during packet transfer. FIG. 1 illustrates an embodiment of an overall packet processing system 10, which depicts data flow, packet page list handle (“phandle”) flow, and constituent hardware blocks.

In some embodiments, a packet phandle serves as a packet pointer pointing to a page of physical memory which contains the packet metadata. For example, each packet phandle is a 32-bit value containing the memory address of a corresponding metadata page in physical on-chip memory. The hardware automatically queues and processes packets using packet phandles. By circulating only the packet phandles, the hardware is able to queue and process packets using only this simple pointer address word without requiring additional software-supplied addressing information. In this example, each page refers to a 256-byte region of physical on-chip memory, with a 256 byte-aligned address. A page pointer is a 32-bit physical address of any 256-byte page, where a page pointer points to the start address of a data page or a packet metadata page. The page list is defined as a list of page pointers stored in the packet metadata page.

Embodiments of the packet processing system convey packets into and out of the MAC layer system in a wireless communication device as serialized byte streams that begin with in-band packet delimiters. The delimiters include metadata related to the subsequent packet data, for example, packet size and packet type information. Conveying such metadata information in the in-band packet delimiters obviates separate mechanisms, for example register writes, to communicate the metadata information.

In some embodiments, the host module and a MAC Programmable Engine (MPE) access packet data via virtual memory data stream interfaces and a contiguous virtual address window of a Packet Virtualization Unit (PVU) 102. The contiguous virtual address window acts as memory mapped regions in which the data is read from or written to. The contiguous virtual address window is used for the creation and consumption of packets. The PVU receives a software access request including a packet pointer and a virtual address for accessing a specific portion of a packet stored in the memory. For host use accesses, the virtual address of the software access request is stream-oriented and unrelated to the physical packet data. For MPE use accesses, the virtual address of the software access request is used to calculate an offset within the physical packet data stored in a memory page. In either case, hardware behind the contiguous virtual page window micro-manages the physical memory storing the packet data. The virtual memory data stream interface resolves virtual references to the appropriate physical memory resources, thereby simplifying memory management for both sides of the MAC layer, requiring only awareness of the virtual memory data stream address on the bus, and reducing the need to exchange additional address-related information.

Accessing a paged packet in software is very time consuming; to improve accessibility, the PVU 102 comprises multiple entries, each provides a virtual address to a packet. Specifically, the PVU 102 allows seamless accessing packet contents in a portion of a given packet according to a virtual address and an offset of the address. The PVU 102 is implemented as a live mapping window for direct random-access reads and writes via entries by the MAC software 104. In some embodiments, individual packet contents are accessible using a Contiguous Virtual Page Window (CVPW) through virtual memory random data interfaces. The CVPW is configured to point to a specific packet in memory and provides a virtual memory space, or packet memory abstraction, that automatically translates accesses from virtual addresses to physical addresses. The MAC software 104, or system Direct Memory Access (DMA), performs read and write operations through a memory-mapped interface while the backing hardware performs redirection to the actual data location in an efficient manner.

In an embodiment of the packet processing system 10, a memory page is a memory region with a predefined size. A page pointer contains a physical memory address for identifying the start of such a memory region corresponding to a memory page. Each packet metadata page stores a page list of page pointers. The page list is created during packet construction, utilized during packet residency for data access, and used to return the pages to free state upon deallocation. A memory page may be free as in unused and not allocated to a packet, or a memory page may be in-use as allocated to a particular packet. In one embodiment, page pointers for free pages are maintained in page pool queues 106. These dedicated queues 106, implemented as hardware FIFOs from which page pointers are popped and appended to a packet's page list. In this embodiment as shown in FIG. 1, the allocation pool queues 106 comprise a transmit (TX) queue, command (Cmd) queue, beacon queue, management (Mgmt) queue, receive (RX) queue, Response (Resp) queue, TX status queue, and acknowledgement (ACK)/local TX queue.

Memory pages are assigned from pools with generic characteristics based on pool identifiers (pool IDs) that are derived from data fields present in the system. In some embodiments, one or more parts of the system expect pool IDs within a certain range and will error out in other cases. For example, certain pool IDs correspond to the TX packet queues that are hardware-defined and not software-configurable. In one embodiment, pools are not completely interchangeable and there are seven different pool IDs, where one pool ID is for RX packets, one pool ID is for responses, one pool ID is for TX status, and four pool IDs correspond to four different TX packet queues. These four pool IDs are for TX packets, commands, beacons, and management respectively.

For each packet, one page is reserved as the packet metadata page storing information about the packet and where the packet data contents are stored. For example, a 256-byte packet metadata page has the following format: address 0x0 corresponds to 4 bytes of packet metadata page word and addresses 0x4 to 0xfc correspond to 252 bytes of a page list. The page list includes the list of page pointers for the pages allocated to the packet when the packet is created, where the number of page pointers correspond to the current packet size divided by 256. This page list is used for data access and then for deallocation at the end. In this example, the first 4 bytes of packet metadata page word indicate information about the packet, such as the packet size, pool ID, state of the packet header, and a 7-bit delimiter Cyclic Redundancy Check (CRC). Some examples of the state of the packet header include unused, allocating, allocation error, in use, write sync error, read sync error, deallocating, and other error. An embodiment of determining the location of a data word in a packet includes calculating the location in the page list for the corresponding page pointer, for example, shifting the virtual address 8 bytes to locate the page list and locating the page pointer, and finally calculating the physical address according to the page pointer.

The embodiment of the packet processing system 10 as shown in FIG. 1 comprises a packet allocator 108, a TX serializer 110, a RX serializer 112, a RX deserializer 114, a TX deserializer 116, and a packet virtualization unit 102. The packet allocator 108 comprises a phandle generator, allocates memory for a new packet, and a phandle deallocator, returns a phandle pointing to the metadata page of the packet back to the allocation pool queues 106. The packet allocator 108 reads the pool ID and packet size from the packet delimiter and allocates one or more pages from the indicated pool associated with the pool ID. Each pool contains a list of free pages. Packet creation and release take and return pages to this pool respectively. The packet allocator 108 examines the pool ID in the packet delimiter and allocates one memory page from the associated pool to be used as the packet metadata page. The packet metadata word is updated with an initial state of “allocating”. The packet allocator 108 then sequentially allocates memory pages for storing the packet contents by popping page pointers from the queue of the pool 106 specified by the pool ID. If the pool is empty before or during page allocation, the packet allocator 108 returns a NULL pointer (0x0) indicating there is not enough memory page in the pool for the packet. The packet allocator 108 rolls back any partial allocations by returning all previously allocated pages to the queue 106 and marking the packet metadata word “allocation error” state. Upon successful page allocation, the packet allocator 108 writes the page list into the packet metadata page, updates the packet metadata word to “in-use,” and returns the phandle pointing to the packet metadata page to the requester. The phandle is also known as the packet pointer referencing the metadata of the packet. The requester is the RX deserializer 114 for receiving a byte stream, or the requester is the TX deserializer 116 for packet transmission. On packet release, the packet allocator 108 returns all memory pages referenced by the page list to the associated page pool 106.

To transfer a packet from a host module to a MAC layer module for transmission (TX) or from a receive (RX) path of the MAC layer module to the host module, the serialized data stream will be written into a deserializer via a system bus. An embodiment of the serialized data stream contains a packet delimiter, followed by packet data, followed by any padding to reach the next 4-byte aligned address. An example of the packet delimiter comprises a packet size, pool ID, padding size, Interrupt Request (IRQ), and delimiter CRC. Detection of a new packet delimiter by the deserializer triggers the packet allocator of the packet processing system to allocate pages from the queue in the pool identified by the packet delimiter. The internal hardware is consequently configured to write the incoming bytes into the allocated physical memory. A TX deserializer 116 coupled to the host module through a host interface 118 receiving a serialized byte stream and deserializing the serialized byte stream into one or more packets, and the packet allocator 108 stores each packet in one or more memory pages of a TX pool in the queues 106. Similarly, a RX deserializer 114 coupled to the MPE receiving an incoming byte stream from the MPE interface 122 and deserializing the incoming byte stream into one or more packets, and the packet allocator 108 stores each packet in one or more memory pages of a RX pool in the queues 106. In this embodiment, the deserializers 114 and 116 create packets on the fly using the packet allocator 108. An embodiment of the packet allocator 108 is configured to resize the RX packets dynamically while receiving the RX byte stream. For example, the RX deserializer 114 issues packet_create and resize operations to the packet allocator 108 to create the packet and write the packet data to the memory. Upon receiving and completion of deserialization of all the packets, the deserializer 114 issues an IRQ interrupt to the software 104.

In some embodiments, a deserializer 114 or 116 takes a received stream of bytes, with delimiters preceding each packet, generates phandles pointing to metadata pages in appropriate pools, populates the packet contents, places phandles into a First In First Out (FIFO) buffer for firmware 104 to inspect or direct. Some embodiments of the FIFO buffer in the packet processing system as shown in FIG. 1 include the RX packet queue 124, TX to PHY queue 126, TX done queue 128, RX to Host queue 130, and RX done queue 132. In one embodiment, the deserializer 114 or 116 presents a write-only and memory-mapped aperture implemented as a contiguous virtual page window, for example, accessible to a 32 kB physical memory region. The base address and window size of the contiguous virtual page window are fixed at chip synthesis according to some embodiments of the present disclosure. A window of this size permits a master writing data to start its address counter at the base address of this window. For example, the master writes data by issuing incrementing writes beginning at the window base address, and the deserializer 114 or 116 consumes the bytes stream in arrival order as the data being written into the deserializer 114 or 116 must arrive in order. The packet allocator 108 allocates physical pages for the packet based on the packet delimiter.

An optional resynchronization feature addresses synchronization errors by automatically resetting an internal state when there is an access starting at the base address of the window, at which point the deserializer resumes delimiter search. In an embodiment, the writing hardware ensures that the new packet delimiters are 4-byte aligned, which implies that padding is applied as required. Once a packet is completely written in the memory, a phandle is pushed to a queue determined by the pool ID in the packet delimiter. An internal controller of the deserializer tracks whether the packet is completely written based on the packet size specified in the packet delimiter. On-chip software can then handle and inspect the packet for further processing upon obtaining the corresponding phandle.

Some embodiments further include an error handling feature. In an example of packet allocation triggered by a packet delimiter in an incoming byte stream, if packet allocation fails because insufficient memory pages are available, a status register is set to indicate that the packet allocation was unsuccessful. This status register stores a copy of the failing delimiter. A host or software checks this status register after a packet transfer through the deserializer to identify packet allocation errors. In cases of multiple packet allocation failures, a register maintains a count of failed packets until it is cleared. In some embodiments, the packet delimiter corresponding to the first failed packet allocation is preserved for software diagnosis and analysis.

A serializer 110 or 112 facilitates the efficient retrieval of data by system hardware, it is accessible via the system bus, enabling the delivery of serialized packet byte streams to downstream packet-data consumers. For example, the downstream packet-data consumers include a host module via a host interface 136 for received data, a MAC accelerator hardware via a MPE interface 134 accessing data for transmission over the air, a DMA engine, and other on-chip logic. Serialized byte streams are made available through the serializer 110 or 112 by placing associated phandles in a queue 128 or 132, which the serializer 110 or 112 accesses a phandle when a new packet is requested. The serializer 110 or 112 functions as a read-only interface, concatenating multiple packets into a contiguous byte stream with per-packet delimiters preceding the associated data. This packet delimiter has the same field layout as the delimiter written into the deserializer, except the interrupt request (IRQ) field set to 0. The serializer maintains state information, tracking the read position within a data packet once a read operation begins and is mapped to a configurable memory region, for example 32 kB, allowing the master 104 to read data continuously with incrementing addresses. Some embodiments of the serializer support resynchronization, a read operation occurs at the beginning of the region resets the internal state, for example, the serializer reads address offset 0x0 to fetch data from the start of the next available packet. The serializer combines the data from all packets in the serializer list into a single contiguous byte stream. The serialization operation is usually triggered by hardware, for example, a Secure Digital Input/Output (SDIO) host interface requesting serialization via accessing data from an appropriate memory address, or an MPE requesting to serialize packets for processing and forwarding to a PHY layer module. An IRQ is issued when the serialization operation is complete. In some embodiments, the status reported by the serializer includes the number of packets remaining to be serialized and the size of the serialized byte stream.

Reads from the serializer are performed on boundaries aligned with the underlying packet data, where misaligned reads may cause an internal read pointer to render subsequent reads inconsistent. In an embodiment, each packet is padded to a 4-byte boundary, as indicated by a padding-size field in the packet delimiter, and receivers are configured to disregard these padding bytes. In a random-access mode, the MPE maintains a fixed internal counter and signals packet completion by issuing a flush command via a hardware interface. Upon completion of serializing a packet, the serializer forwards the associated phandle to a dedicated queue accessible to software, and, in certain embodiments, to hardware configured to automatically deallocate packet pages following off-chip transfer to a host module.

In some embodiments, the response of a serializer to a read operation at address offset 0x0 is configurable via a control register and supports three modes. In first mode, the packet-resume mode, the access of data at address offset 0x0 is ignored; the serializer continues to output data from its current internal state. The serializer fetches a new phandle from the queue when it is idle, otherwise, it resumes transmitting the current packet data until completion, at which point it fetches the next packet. In second mode, the packet-restart mode, the address resets to 0x0 occurring when reading out a packet causes the serializer to restart the read-out of the current packet from the beginning of the packet (i.e. from address offset 0x0), including the packet delimiter. In third mode, the packet-skip mode, a 0x0 access occurring during reading out a packet is treated as a resynchronization event. The serializer updates the affected packet metadata word of the phandle with a read-synchronization-error indication, forwards that phandle for handling, and advances to the next phandle for processing the next packet. In this packet-skip mode, any partially read phandles are placed into the serializer output queue without automatic deallocation, irrespective of the auto-deallocation register setting. In some embodiments, a counter is incremented on each packet-skip event caused by resynchronization, thereby providing a measurable indication of synchronization faults. This counter may be software-readable and clearable to facilitate monitoring and diagnosis.

In certain embodiments, a deserializer and a serializer share a unified address space. The destination for each access is determined by the type of operation. Writes to the shared space are directed to the deserializer, and reads are directed to the serializer. This unified address configuration is applicable to both the host deserializer and serializer as well as the MPE deserializer and serializer, where the access type dictates the specified target within the shared address space.

In the packet processing system described herein, packets stored in the memory are represented as fragmented sets of memory pages. The packet allocator dynamically assigns one or more memory pages from a selected pool to store each packet, where each packet is associated with a packet pointer that references a metadata of the packet. The metadata may be stored in a metadata page allocated to the packet and may include, for example, a page list identifying the memory pages assigned to store packet contents, a packet size, packet type, and other control information. Because each packet may span multiple non-contiguous memory pages, direct software access to such fragmented packets can require traversal of multiple memory pages and repeated interpretation of page list information. To address these limitations, the PVU is configured to expose a virtual contiguous address mapping for the packets stored in the memory. The PVU provides software with a logically contiguous view of a packet, even though the packet is physically stored across multiple non-contiguous memory pages allocated by the packet allocator.

In operation, the PVU is configured to receive a software access request including a given packet pointer and a virtual address for accessing a specific portion of a given packet. The given packet pointer references a metadata of the given packet stored in a metadata page. Upon receiving the software access request, the PVU retrieves the metadata referenced by the packet pointer and constructs a contiguous virtual page window corresponding to the given packet according to the metadata. The contiguous virtual page window represents a logically linear address space spanning the entirety of the given packet, independent of the physical arrangement of the memory pages storing the packet.

The Contiguous Virtual Page Window (CVPW) is designed to facilitate efficient access to packet contents by software. By providing virtual address mapping to packet data, the CVPW avoids the overhead associated with software-based paging mechanisms, enabling seamless read and write operations. CVPW maintains an address-translation cache to improve performance by avoiding redundant page lookups within a packet. The CVPW allows access to a virtual address and offset which automatically resolves the corresponding location in the packet content and permits software to easily read or modify packet data without manual paging. More specifically, the PVU determines a physical address of the memory page storing the requested portion of the given packet, as well as an offset within the memory page, which allows direct access to the requested portion of the given packet. The PVU translates the virtual address using the contiguous virtual page window to determine a particular memory page assigned to the given packet and an intra-page offset corresponding to the requested portion. The PVU then outputs the physical address and the offset within the memory page for direct access to the requested portion of the given packet. The PVU maps memory reads and writes directed to the virtual contiguous page window into corresponding physical memory accesses to the underlying memory pages assigned to the packet. The software thereby interacts with the packet as if the packet were stored in a single contiguous memory region, without being required to traverse individual memory pages or interpret page list entries. It provides direct access to packet data, which is suitable for real-time operations like frame-type inspection or post-processing. The PVU reduces processor overhead associated with page-by-page traversal, improves memory access efficiency, and enables faster and more accurate packet processing. This hardware-assisted virtualization of packet memory enhances throughput and reduces latency within the packet processing system of the wireless communication device.

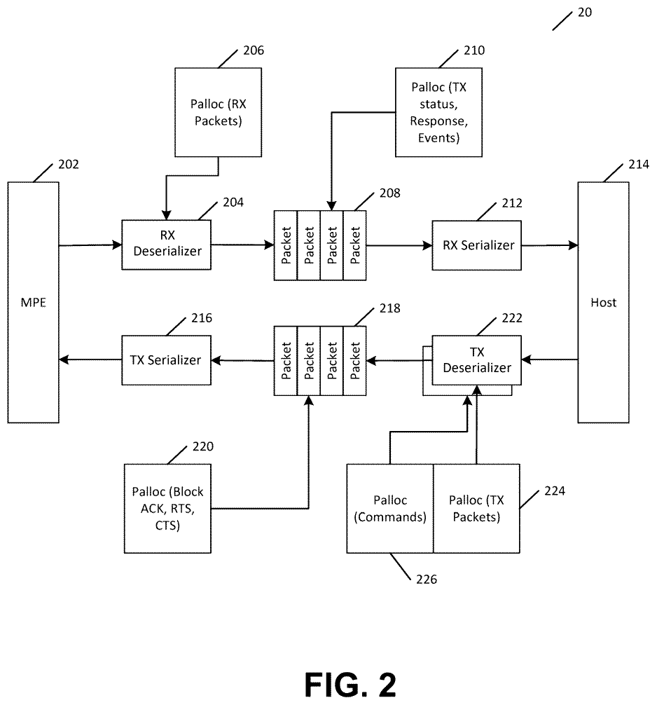

FIG. 2 illustrates an embodiment of a system 20 employing multiple serializers and deserializers to support wireless reception and transmission by a wireless communication device operating in a wireless communication network. MPE hardware executes command sequences fetched from memory and interrupts a MAC layer software thread when executing commands until the end of the command sequence. On the RX path, the MPE 202 writes a received byte stream into a RX deserializer 204; a packet allocator 206 allocates memory pages storing the received packets and assigns a phandle for each received packet. The RX deserializer 204 splits the received byte stream into meaningful packets to reconstruct the original packet structure from the serialized byte stream. In one embodiment, the serialized byte stream is converted from modulated signals received by the RF modem or transceiver of the wireless communication device. The deserialized packets are placed in a queue 208 by a packet allocator 210 for retrieval and serialized for reading at the host interface. An embodiment of the packet allocator 210 allocates the packets according to the TX status, response, and events. These deserialized packets are written to a RX serializer 212 for serialization, and the host module 214 reads serialized packets from the packet receiving serializer address through the host interface. On the TX path, a TX deserializer 222 coupled to the host interface receives a serialized byte stream from the host module 214 and deserializes into TX packets according to the packet allocator 224 which allocates one or more memory pages to the TX packets. In FIG. 2, the TX deserializer 222 coupled to the host interface is controlled by a packet allocator 226 according to the commands. The TX deserializer 222 outputs the deserialized packets to a TX packet queue 218 in accordance with a packet allocator 220 based on control signals from the MAC layer module. Some examples of the control signals include Block acknowledgement (ACK), request to send (RTS), and clear to send (CTS). A Block ACK is used to consolidate multiple individual ACKs into one for multiple frames or an aggregated form of frames successfully received. An RTS is used when the wireless communication device is transmitting data to an intended recipient, and a CTS is used when the wireless communication device is ready to receive data. Packets in the TX packet queue 218 are transferred to a TX serializer 216 requested by the MPE 202 to serialize packets to the PHY layer. The TX serializer 216 produces a byte stream in known formats that carries the data in the packets and provides the byte stream to the MPE 202.

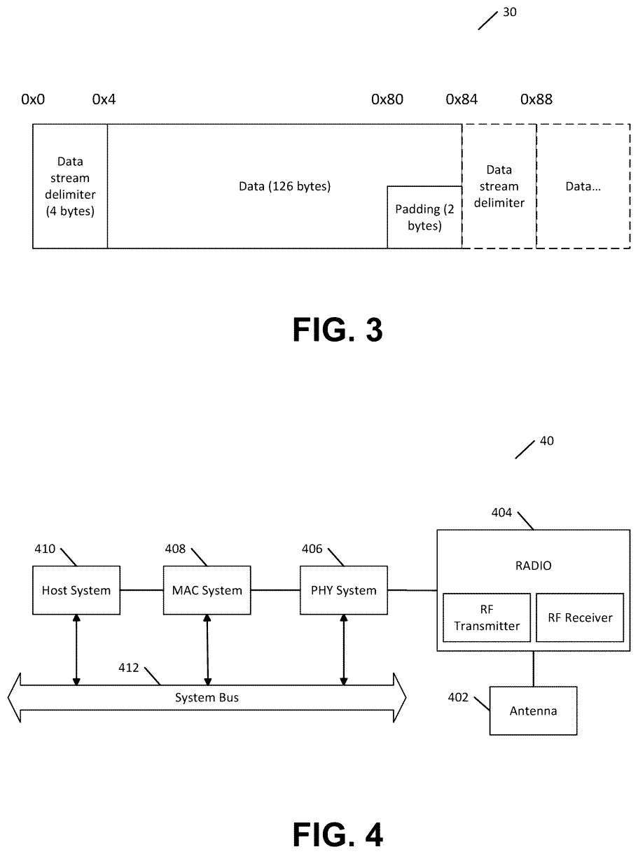

FIG. 3 illustrates an embodiment of a data byte stream 30 that carries packets transferred to a deserializer's virtual memory window. At the start of the byte stream 30, a data stream delimiter is transmitted, followed by the data of the packet (i.e. packet payload) and any necessary padding to ensure that the write operation terminates on a 4-byte aligned address. In this embodiment, the packet payload is 126 bytes, requiring 2 bytes of padding. After the padding, the data stream delimiter and packet payload of a subsequent packet are sent. Upon receipt of a new packet delimiter, the deserializer allocates memory for the corresponding new packet. The serializer utilizes a packet allocator to reserve memory within the system for the packet prior to configuring its internal CVPW-like hardware to write the incoming bytes into the allocated packet buffer. Memory pages are drawn from the queue identified by the pool ID field of the data stream delimiter.

In some embodiments, the host interface incorporates its own serializer-deserializer pair with in-band delimiters that specify the memory pool used to back the packet being operated on. Host command pages and responses are thereby isolated from TX and RX flows without the need for centralized priority management. A centralized memory block tracks the number of packets or pages queued for serialization and tracks the number of empty pages available for deserialization. Each serializer or deserializer has a unique address on the interface, where reading from or writing to an address activates the serialization or deserialization operation of the matching serializer or deserializer. In some embodiments, a consolidated status block aggregates queue depth, page availability, and serializer or deserializer state for multiple serializer and deserializer. For example, a unified status register or memory block is retrievable by a single read operation, reports per-serializer queue depth and per-deserializer free-page availability for all the serializers and deserializers. The benefits of this packet processing system include efficient resource management by providing a real-time view of the serializer or deserializer status, and reduced contention by implementing independent serializers and deserializers for command, response, TX packet, and RX packet flows.

Embodiments of the packet processing system comprise hardware FIFO queues implemented by on-chip and memory-mapped SRAM and are initialized by software, for example with the initialization including allocating a specific memory region for each queue and configuring the maximum capacity in terms of the number of entries it can hold. Some embodiments of the FIFO queues are for storing 32-bit data words as a page pointer or a packet phandle is a 32-bit value representing the physical address of a page. Both hardware and software interfaces are provided for pushing 32-bit values into the queue and popping values off in a FIFO order. The queues are safeguarded against simultaneous access by hardware and software according to an embodiment. For example, internal serializer and deserializer queues are exclusively accessed by hardware, whereas software cannot access the internal deserializer or serializer queues while they are being used by hardware. In one embodiment, shared pool queues are larger queues that manage free pages, simultaneous access by multiple hardware and software components is supported. These accesses are arbitrated in a round-robin manner to ensure fairness among all masters. Each page-pool queue is implemented as a hardware-managed FIFO storing page pointers each pointing to a 256-byte-aligned physical page. Upon packet allocation, page pointers are popped from the pool designated for the packet type; upon de-allocation, page pointers are returned to the same pool. Pool selection may be determined by a pool identifier (pool ID) conveyed in an in-band delimiter or other control field.

In some embodiments, the packet processing system maintains memory comprising pools of memory pages, one or more pools are dedicated to a respective packet type or traffic flow. An embodiment of the packet processing system comprises a dedicated pool of free pages for each packet type. Grouping free pages by intended packet type improves allocation locality and reduces contention, thereby enabling efficient memory utilization and management during packet creation and release.

The packet processing system further provides an interrupt mechanism enabling multiple interrupt sources within the block to assert external interrupts. In a representative implementation, two major external interrupt sources, one is an applications processor core and another is a MAC processor core. Certain conditions for software intervention, for example, an error will trigger an interrupt from another hardware block. In an example, when phandle generation fails due to page exhaustion, a deserializer asserts an interrupt.

In some embodiments, each FIFO queue instance supports watermark interrupt and empty pop/full push. A watermark interrupt is generated when the FIFO queue depth, also referred to as the populated count, crosses a programmable watermark threshold. For example, the programmable watermark threshold may be crossed by a push operation, when the increased queue depth reaches the threshold, or a pop operation, when the reduced queue depth reaches the threshold. A watermark interrupt is triggered when a pop operation is attempted on an empty FIFO queue, when the queue depth is zero, or a push operation is attempted on a full FIFO queue, when the queue depth equals its capacity; in such cases, the interrupt may be routed to an encapsulating hardware block for handling rather than directly to software thread.

In some embodiments, the interrupts from particular sources are combinable into one or more interrupt groups. For each group, software is provided with: (i) an Enable register (read/write) with per-source mask bits, where each bit enables or disables a particular interrupt by ignoring it; (ii) a Pending register (read-only) whose per-bit state indicates if an interrupt has fired since the last claim event; and (iii) a Claim register (read-only) that mirrors the Pending register, wherein a read of the Claim register clears all bits of the corresponding Pending register. An interrupt arriving coincidently with a claim event still drives the relevant bit in the Pending register to go high following the claim event, ensuring no loss of edge events. Some embodiments of each interrupt group communicate to software via a platform interrupt controller, in an example, two interrupt groups only result in two software-visible interrupts.

FIG. 4 shows a high-level block diagram of a wireless communication device 40 that implements an embodiment of the packet processing system. The wireless communication device 40 manages a Medium Access Control (MAC) layer and a Physical (PHY) layer in compliance with an IEEE 802.11 standard. The wireless communication device 40 is a Station (STA) or an Access Point (AP) of a wireless network. For example, the wireless communication device 40 is in a mobile device, a personal computer, a laptop computer, an Internet of Things (IoT) device, a wearable device, an extended reality device, a video server, a camera, or a communication device on a vehicle. The wireless communication device 40 has a radio module 404 including an RF transmitter and an RF receiver. The wireless communication device 40 further includes an antenna unit 402, a communication system bus 412, a MAC system 408, a PHY system 406, and a HOST system 410. These systems may be implemented individually or in combination with various types of Integrated Circuit (IC), including one or more of a Graphics Processing Unit (GPU), an Application Specific Integrated Circuit (ASIC), or Reduced Instruction Set Computer-Five (RISC-V). The PHY system 406 bridges between the MAC system 408 and the radio front-end 404 and is responsible for modulation and demodulation. Specifically, the packets are transmitted by modulating one or more carrier wave signals to encoded digital information according to a clock signal. Received packets are demodulated to reconstruct the original digital information according to the clock signal. The Host system is responsible for running high level functionalities of the wireless communication device 40. The PHY system 406, the MAC system 408, the HOST system 410 communicate with each other via the system bus 412. The antenna unit 402 may include a single antenna or multiple antennas.

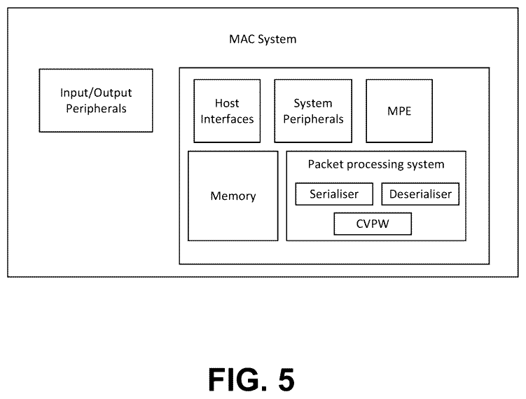

FIG. 5 illustrates a simplified block diagram of a MAC system according to an embodiment of the present disclosure. The MAC system includes a Host interface, system peripherals, MPE, memory, and an embodiment of the packet processing system. The memory stores software codes for the MPE and packet processing system. The MPE executes MAC level instructions and manages the interface between the application software and wireless medium through a PHY processor in the PHY system. The MPE is responsible for coordinating access to the wireless medium so that the AP and STAs in range can communicate effectively. The MPE and the packet processing system add packet delimiters to the packet payloads provided by the higher levels and sends them to the PHY layer for transmission. The reverse happens when receiving packets from the PHY layer. The MAC system further includes Input/output peripherals that allow exchange of information with other systems, such as General Purpose Input Output (GPIO) interfaces and Universal Asynchronous Receiver-Transmitter (UART). The system peripherals may include timers, interrupts, radio/filters/system registers, and counters. Memory stores and page pools and queues used by the packet processing systems. Memory may include one or a combination of Random-Access Memory (RAM) such as Synchronous Dynamic Random-Access Memory (SDRAM), Read-Only Memory (ROM), Non-Volatile Random-Access Memory (NVRAM), Electrically Erasable Programmable Read-Only Memory (EEPROM), FLASH memory, magnetic or optical data storage media, and the like.

Although aspects of the disclosure are illustrated and described herein with reference to specific embodiments, the scope is not intended to be limited to the details shown. Rather, various modifications may be made in the details within the scope and range of equivalents of the claims and without departing from the disclosure. It is to be understood that the above description is illustrative of aspects of the disclosure and is not to be construed as limiting. Various modifications, applications and/or combinations of the embodiments may occur to those skilled in the art without departing from the scope of the disclosure and embodiments herein as defined by the claims. Well-known circuits, processes, algorithms, structures, and techniques may be shown without unnecessary detail to avoid obscuring the aspects.

Processes and methods according to the above-described examples can be implemented using computer-executable instructions that are stored or otherwise available from computer-readable media. Such instructions can include, for example, instructions and data which cause or otherwise configure a general-purpose computer, special purpose computer, or a processing device to perform a certain function or group of functions. Portions of computer resources used can be accessible over a network. The computer executable instructions may be, for example, binaries, intermediate format instructions such as assembly language, firmware, source code, etc. Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks may be stored in a computer-readable or machine-readable medium. The techniques additionally, or alternatively, may be realized at least in part by a computer-readable communication medium that carries or communicates program code in the form of instructions or data structures and that can be accessed, read, and/or executed by a computer, such as propagated signals or waves. The program code may be executed by a processor, which may include one or more processors, such as one or more Digital Signal Processors (DSPs), general purpose microprocessors, an Application Specific Integrated Circuits (ASICs), Field Programmable Logic Arrays (FPGAs), or other equivalent integrated or discrete logic circuitry. Such a processor may be configured to perform any of the steps described in this disclosure. A general-purpose processor may be a microprocessor; alternatively, the processor may be any conventional processor, controller, microcontroller, or state machine. A processor may also be implemented as a combination of computing devices.

To clearly illustrate the interchangeability of hardware and software, various illustrative components, blocks, modules, engines, circuits, and steps have been described above generally in terms of their functionality. Whether such functionality is implemented as hardware or software depends upon the application and design constraints imposed on the overall system. Skilled artisans may implement the described functionality in varying ways for each application, but such implementation decisions should not be interpreted as causing a departure from the scope of the present application.

What is claimed is:

1. A packet processing system for a wireless communication device operating in a wireless communication network, comprising:
a memory comprising a plurality of memory pages organized into pools of memory pages;
a packet allocator, configured to dynamically assign one or more memory pages from the pools of memory pages to store each packet, and to associate each stored packet with a packet pointer that references a metadata of the stored packet;
a receiver (RX) deserializer, configured to: receive an RX byte stream from a Medium Access Control (MAC) layer, reconstruct a plurality of RX packets from the RX byte stream, and store the plurality of RX packets in an RX pool of memory pages allocated by the packet allocator, wherein the RX pool is within the pools of memory pages;
an RX serializer, coupled to the memory and configured to serialize the plurality of RX packets stored in the RX pool of memory pages and to output a host-bound serial stream to a host module through a host interface;
a transmitter (TX) deserializer, configured to: receive a serialized byte stream from the host module through the host interface, form a plurality of TX packets from the serialized byte stream, and store the plurality of TX packets to a TX pool of memory pages dynamically allocated by the packet allocator, wherein the TX pool is within the pools of memory pages;
a TX serializer, configured to convert the plurality of TX packets stored in the TX pool of memory pages into a TX byte stream for transmission; and
a packet virtualization unit (PVU), configured to expose a virtual contiguous address mapping for at least one packet stored in the memory, wherein the PVU is configured to: receive a software access request comprising a given packet pointer and a virtual address for accessing a portion of a given packet, retrieve a metadata referenced by the given packet pointer to offer a contiguous virtual page window, and translate the virtual address using the contiguous virtual page window to determine a physical address of the memory page for storing the portion of the given packet and an offset within the memory page.

2. The packet processing system of claim 1, wherein:
the packet allocator assigns the one or more memory pages from the pools of memory pages to store each packet according to a traffic flow of each packet;
the traffic flow is selected from a group of types of traffic flow comprising at least one of a transmit traffic flow, a receive traffic flow, a command traffic flow, and a response traffic flow; and
at least one pool included in the pools of memory pages is used to store respective packets belonging to each type of traffic flow included in the group of types of traffic flow.

3. The packet processing system of claim 1, wherein the packet allocator is configured to resize the RX packets dynamically while receiving the RX byte stream.

4. The packet processing system of claim 1, wherein the packet virtualization unit comprises a plurality of mapping entries, each mapping a RX or TX packet into the contiguous virtual page window accessible by software for reading and writing.

5. The packet processing system of claim 4, wherein the RX deserializer or the TX deserializer addresses synchronization errors by automatically causing a reset of an internal state based on the software access request starting at a base address of the contiguous virtual page window, and the RX deserializer or TX deserializer searches for a delimiter.

6. The packet processing system of claim 1, wherein each of the RX packets and TX packets comprises a delimiter including metadata indicating a packet size and type.

7. The packet processing system of claim 6, wherein, to assign the one or more memory pages for each packet, the packet allocator is configured to use the packet pointer to point to a corresponding metadata page allocated to each packet.

8. The packet processing system of claim 1, wherein the packet allocator is configured to examine a pool identifier (ID) contained in a delimiter of the RX byte stream, select the RX pool of memory pages corresponding to the pool ID, assign one memory page from the RX pool to be used as a metadata page for a reconstructed RX packet, assign one or more memory pages from the RX pool to store packet contents of the reconstructed RX packet, and write a page list into the metadata page identifying the one or more memory pages assigned to store the packet contents.

9. The packet processing system of claim 1, wherein the RX deserializer and TX deserializer reconstruct the RX packets and TX packets on the fly using the packet allocator.

10. The packet processing system of claim 1, further comprising a register configured to indicate packet allocation is unsuccessful when there is a lack of available memory pages in a respective pool, wherein the register stores a copy of a delimiter.

11. The packet processing system of claim 1, wherein each of the RX and TX serializers functions as a read-only interface, wherein the RX serializer is triggered by the host module to read packet contents stored in the RX pool of memory pages; the TX serializer is triggered by the MAC layer to read packet contents stored in the TX pool of memory pages; wherein each of the RX and TX serializers maintains state information and tracks a current read position within a packet.

12. The packet processing system of claim 1, wherein the packet allocator assigns the memory pages for the RX packets in accordance with one or a combination of a TX status, response, and events, wherein the packet allocator assigns the memory pages for the TX packets in accordance with a control signal from the MAC layer.

13. The packet processing system of claim 12, wherein the control signal issued from the MAC layer comprises one or a combination of a block acknowledgement (ACK), request to send (RTS), and clear to send (CTS).

14. The packet processing system of claim 1, wherein the RX and TX pools of memory pages for storing the RX packets and the TX packets comprise an on-chip memory-mapped random access memory (RAM).

15. The packet processing system of claim 1, further comprising a unified status block across the RX deserializer, RX serializer, TX deserializer, and TX serializer, for aggregating a queue depth, page availability, and state of the RX deserializer, RX serializer, TX deserializer, and TX serializer.

16. The packet processing system of claim 1, wherein the software access request is for a memory read or write operation initiated by software instructions, and the PVU is configured to output the physical address and the offset within the memory page such that the software accesses the portion of the given packet directly using the physical address and the offset.

17. The packet processing system of claim 1, wherein the PVU enables sequential software access across multiple non-contiguous memory pages as a logically contiguous memory region according to the virtual contiguous address mapping.

18. A wireless communication device operating in a wireless communication network, comprising:
a radio module, comprising a Radio Frequency (RF) transmitter and an RF receiver;
a Physical (PHY) system, coupled to the radio module, and configured to demodulate a received signal received by the RF receiver and modulate into a transmit signal to be transmitted by the RF transmitter;
a host system, running high level functionalities of the wireless communication device; and
a Medium Access Control (MAC) system, coupled to the PHY system and the host system, comprising:
a memory comprising a plurality of memory pages organized into pools of memory pages;
a packet allocator, configured to assign one or more memory pages from the pools of memory pages to store each packet, and to associate each stored packet with a packet pointer that references a metadata of the stored packet;
a receiver (RX) deserializer, configured to: receive an RX byte stream from the PHY system, reconstruct a plurality of RX packets from the RX byte stream, and store the RX packets in an RX pool of memory pages allocated by the packet allocator, wherein the RX pool is within the pools of memory pages;
a RX serializer, coupled to the memory and configured to serialize the RX packets stored in the RX pool of memory pages and output a host-bound serial stream to the host system;
a transmitter (TX) deserializer, configured to receive a serialized byte stream from the host system, form a plurality of TX packets from the serialized byte stream, and store the plurality of TX packets to a TX pool of memory pages dynamically allocated by the packet allocator, wherein the TX pool is within the pools of memory pages;
a TX serializer, configured to convert the plurality of TX packets stored in the TX pool of memory pages into a TX byte stream for the PHY system; and
a packet virtualization unit (PVU), configured to expose a virtual contiguous address mapping for at least one packet stored in the memory, wherein the PVU is configured to: receive a software access request comprising a given packet pointer and a virtual address for accessing a portion of a given packet, retrieve a metadata referenced by the given packet pointer to offer a contiguous virtual page window, and translate the virtual address using the contiguous virtual page window to determine a physical address of the memory page for storing the portion of the given packet and an offset within the memory page.
